(19) United States
(12) Patent Application Publication
(10) Pub. No.: US 2017/0278095 A1
(43) Pub. Date: Sep. 28, 2017

(54) MOBILE PAYMENT SYSTEM AND METHOD

(71) Applicant: Microsoft Technology Licensing, LLC, Redmond, WA (US)

(72) Inventors: Ross David Heeter, Redmond, WA (US); Isaac Sung Wai Yuen, Bellevue, WA (US); Cole James Menard, Woodinville, WA (US)

(73) Assignee: Microsoft Technology Licensing, LLC, Redmond, WA (US)

(21) Appl. No.: 15/177,263

(22) Filed: Jun. 8, 2016

Related U.S. Application Data
(60) Provisional application No. 62/314,299, filed on Mar. 28, 2016.

(51) Int. Cl. G06Q 20/34; G06Q 20/32

(52) U.S. Cl. CPC G06Q 20/353; G06Q 20/32

(57) ABSTRACT

A user account server is provided herein the user account server includes code stored in memory executable by a processor to determine a mobile payment card list associated with a mobile computing device in response to receiving a mobile payment card list request, the mobile payment card list including a plurality of mobile payment cards, determine an eligibility of each mobile payment card in the mobile payment card list based on at least one eligibility parameter, if a mobile payment card is determined to be ineligible, selectively remove the ineligible mobile payment card from the mobile payment card list to generate a list of eligible mobile payment cards, and send an eligible card data set corresponding to the list of eligible payment cards to the mobile computing device.

### CROSS REFERENCE TO RELATED APPLICATION

This application claims priority to U.S. Patent Application No. 62/314,299 entitled “MOBILE PAYMENT SYSTEM AND METHOD”, filed Mar. 28, 2016, the entirety of which is hereby incorporated herein by reference.

### BACKGROUND

Mobile payment systems can enable mobile devices to function as virtual wallets with mobile payment (e.g., credit, debit, and gift) cards, membership cards, and loyalty cards stored therein. In many cases, users have to manually enter card information (i.e., identification information, account numbers, security codes, etc.,) into the user's mobile device to place the card within the virtual wallet. Manual entry can be tedious, time consuming, and prone to error. A separate issue is eligibility verification. This is employed in many cases as a threshold determination as to whether a given card can be used in a mobile wallet system for a monetary transaction, for example to prevent unwanted or fraudulent card use. However, typical systems assess eligibility through the payment card's network while a transaction is occurring or just before a transaction. This can introduce inefficiencies, cause user frustration, and otherwise detract from the user experience. These issues diminish the appeal of the virtual wallet in relation to traditional forms of payment.

### BRIEF DESCRIPTION OF THE DRAWINGS

FIG. 1 depicts an example computing system configured to implement mobile wallet functionality in a mobile computing device.

FIG. 2 depicts exemplary eligibility parameters used to determine mobile payment card eligibility in the computing system shown in FIG. 1.

FIGS. 3-4 show an example method for operating a computing system to provide mobile wallet functionality.

FIGS. 5-8 show example user interfaces that may be employed in connection with providing mobile wallet functionality.

FIG. 9 depicts a computing system that may be employed in connection with the mobile wallet functionality described in connection with FIGS. 1-8 and otherwise herein.

### DETAILED DESCRIPTION

The present disclosure contemplates a mobile payment system, in which one or more mobile payment cards is configured, via an automated eligibility verification process, for use in a mobile wallet program of a smart phone or other mobile computing device. This, in conjunction with other features, can streamline setting up, maintaining, and using a mobile wallet. In one example set-up scenario, launching of a mobile wallet app automatically initiates the sending of a mobile payment card list request to a user account server. The user account server then searches for mobile payment cards in an associated user account. The user account may correspond to the mobile device being used, and/or may be connected to a specified user.

The user account server may then determine, for each of the retrieved mobile payment cards, whether that card is eligible for use in a mobile wallet application. Eligibility may be based on eligibility parameters such as whether the card has been suspended (e.g., due to suspected fraud or exceeding of credit limit), whether the card has expired, verification parameters, card type parameters, user preferences, etc. Having made the eligibility assessment, the user account server then removes cards from the retrieved list that are ineligible. A card data set corresponding to the curated list is then sent to the mobile computing device from the user account server. The card data set may include any data that is needed in order to allow the eligible cards to be used for mobile payments or other functionality associated with the mobile wallet application. The pre-enrollment eligibility screen streamline set up and can avoid various issues that can cause user frustration, inefficient/compromised functionality, transaction failures, and security risks.

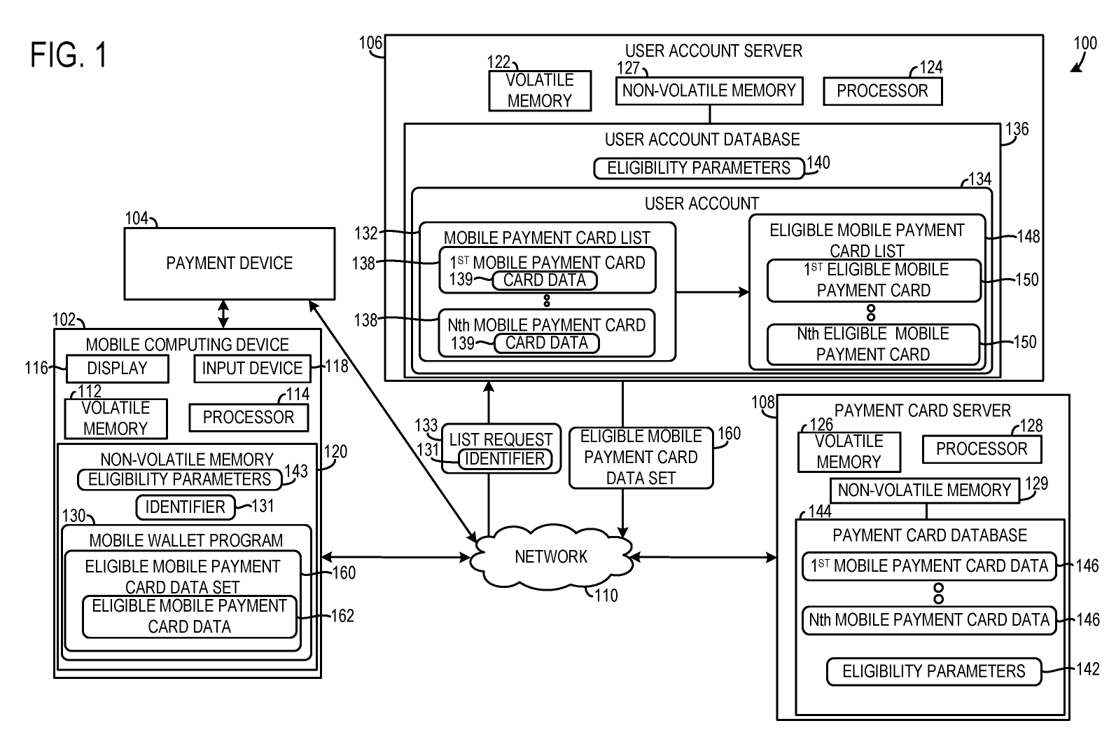

FIG. 1 schematically depicts a computing system 100 that may be used to implement mobile wallet functionality is described herein. Computing system 100 includes a mobile computing device 102, a payment device 104 (e.g., point of sale (POS) device), a user account server 106, and a payment card server 108. The mobile computing device 102, payment device 104 (e.g., point of sale (POS) device), user account server 106, and payment card server 108 may be configured to electronically communicate over any type of network 110 (the Internet, a WAN, LAN, etc.)

As indicated, mobile computing device 102 may include a volatile memory 112, a processor 114, a display 116, an input device 118 (e.g., touch screen, keyboard, mouse, trackpad, etc.) and non-volatile memory 120 (e.g., mass storage). In typical implementations, mobile computing device 102 will be a smartphone. User account server 106 may include similar components—i.e., a volatile memory 122, processor 124, and non-volatile memory 127. Similarly, payment card server 108 may include a volatile memory 126, a processor 128, and non-volatile memory 129. It will be appreciated that code may be stored in the volatile memory 112, 122, 126 and the non-volatile memory 120, 127, 129. The code may include the steps, instructions, functions, etc., described in greater detail herein.

A mobile wallet program 130 is stored in non-volatile 120 in the mobile computing device 102. Set up of the mobile wallet program in some cases is initiating in response to launching the program. Responsive launch, a request 133 for a list of mobile payment cards may be automatically sent to the user account server 106. The mobile payment cards may include credit, debit, gift cards, and/or other types of cards that enable a monetary exchange for goods and/or services. This request triggers automated set up of mobile payment cards within the mobile wallet program, thereby reducing the time, effort and potential error associated with manual user input steps.

Among other things, the request may include a user or mobile device identifier 131 (e.g., a token), enabling the user account server 106 to identify the user of the mobile computing device 102. The identifier 131 may also be stored in the mobile computing device 102. The device or user identifier 131 may include any type of information to enable the mobile computing device or user associated with the mobile computing device to be correlated to a previously generated user account 134 associated with the device/user.

In response to receiving the request 133, the user account server 106 may locally determine a mobile payment card list 132. Such a list may be stored, for example, within a user account database 136 holding the user account 134 (as well as the user accounts of many other users/devices). As previously indicated, the user account 134 may be associated with the mobile computing device 102 and/or a specific user of the mobile computing device.

The mobile payment card list 132 may include a number of mobile payment cards 138, each with corresponding card data 139 (card issuer, account numbers, security codes, expiration dates, PIN codes, cardholder information, etc.).

In one example involving set-up by the user, user account 134 may be configured prior to launching the mobile wallet program 130. In this case, the user account 134 may be established after a user signs up for another program/service provided by the user account server 106. For example, a user may sign up for digital downloads, music/video streaming, pay for items ordered online, etc., some or all of which may be supported/offered by the user account server 106, and which entail the user providing one or more payment cards for handling purchases on the platform. Enrolling the payment card typically will involve providing a username, password, and payment card data (e.g., card issuer, name, card number, security code, expiration date, etc.). The data gathered during set-up of the digital media service or e-commerce platform is then stored in the user account 134 for later use. In this way, user account data can be shared across various services of the user account server 106. In some examples, the user account server 106 and/or mobile payment device 104 may set permissions related to access of the user account 134 to prevent unwanted access of the account data. The above should be understood as non-limiting examples—the present disclosure contemplates any method for populating the user account with cards that could eventually be used in a mobile wallet.

The user account server 106 may also be configured to determine eligibility of each of the mobile payment cards 138 in the mobile payment card list 132. In particular, the user account server 106 may be configured to determine card eligibility based on eligibility parameters 140 stored in the user account database 136. The eligibility parameters 140 may include eligibility parameters set by the user account server 106, mobile computing device 102, and/or payment card server 108. In the depicted example, eligibility parameters 142 and 143 are stored in and associated with payment card server 108 and mobile computing device 102, respectively. The eligibility parameters 142 are stored in a payment card database 144 in the payment card server 108. It will be appreciated that the payment card server 108 and the mobile computing device 102 are configured to send eligibility parameters to the user account server 106 responsive to a request, at predetermined time intervals, and/or according to any other suitable timing.

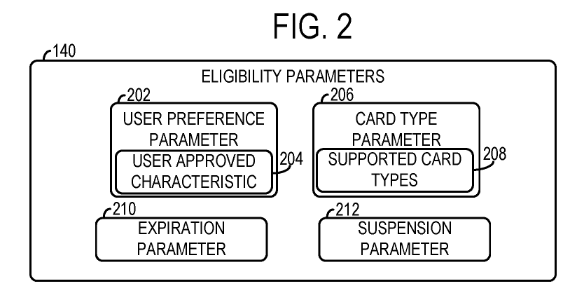

Specific examples of the eligibility parameters 140 are shown in FIG. 2. The eligibility parameters 140 illustrated in FIG. 2 are discussed with regard to the functions of the mobile computing device 102, the user account server 106, and the payment card server 108 (FIG. 1). The eligibility parameters 140 in FIG. 2 include a user preference parameter 202. The user preference parameter 202 designates a user-approved mobile payment card characteristic 204. The user-approved mobile payment card characteristic may be the mobile payment card's issuer, a purchase/credit limit of the mobile payment card, etc. When the user preference parameter 202 is used to determine eligibility of a mobile payment card, a characteristic of the mobile payment card may be compared with the user-approved mobile payment card characteristic 204. If the user-approved mobile payment card characteristic 204 matches the characteristic of the mobile payment card, then the mobile payment card is identified with an eligible status. For instance, a user may generate a list of approved card companies such as “card company ABC” and “card company 123.” If a mobile payment card is issued by “card company ABC” the user-approved card characteristic matches the characteristic of the mobile payment card. The matched characteristics in this example lead to the card being deemed as eligible. On the other hand, a mismatch leads to the card being identified as ineligible. In this way, a user can tailor card eligibility according to their preferences.

Certain types of payment cards may not support card use in mobile payment platforms due to deficiencies in their payment processing system, issuer preferences, programming incompatibilities, security concerns, or various other reasons. Thus, the eligibility parameters 140 may also include a card type parameter 206 designating card types 208 (e.g., debit, credit, gift, card issuer, etc.) that are supported by the user account server 106 and/or the payment card server 108. As such, if the card type of a mobile payment card matches an eligible card type the mobile payment card is deemed to be eligible and if the card type of a mobile payment card doesn't match an eligible card type the mobile payment card is deemed to be ineligible.

The eligibility parameters 140 further include an expiration parameter 210 set by the payment card server 108 and sent to the user account server 106. The expiration parameter 210 enables the user account server 106 to ascertain if a mobile payment card has an expired/unexpired state indicating an ineligible/eligible status. In this way, only active payment cards have eligibility, preventing unsuccessful attempts to use the mobile payment card in a subsequent transaction.

The eligibility parameters 140 also include a suspension parameter 212. The suspension parameter 212 may also be set by the payment card server 108 and sent to the user account server 106, in one instance. The suspension parameter 212 enables the user account server 106 to determine if a mobile payment card is in a suspended or unsuspended state. In one instance, the mobile payment card may be set in a suspended state when fraudulent use flags are triggered. The triggers can include high value transactions, transactions in irregular locations, repetitive transactions, etc. For instance, if one or more transactions exceed a threshold value a fraudulent use flag may be triggered. In another example, if a geolocation of a transaction is outside a predetermined range a fraudulent use flag may be triggered. The suspended state may be discontinued and the cards state may return to being unsuspended when a user verifies recent transactions or otherwise confirms that fraudulent card use is not occurring. If the mobile payment card is in a suspended state the mobile payment card is identified as being ineligible. On the other hand, if the mobile payment card is in an unsuspended state the mobile payment card is identified as being eligible. In this way, mobile payments cards which are suspected as being compromised with regard to fraudulent activity are deemed to be ineligible.

Continuing with FIG. 1, once the eligibility of the mobile payment cards is determined by the user account server 106, the mobile payment card list 132 may be narrowed down by removing any ineligible mobile payment cards from the list. As such an eligible mobile payment card list 148 including one or more eligible mobile payment cards 150 may be stored in the user account 134. In this way, the list of mobile payment cards can be curated according to card eligibility to simplify and speed-up mobile wallet set-up and eliminate redundant steps during mobile wallet set-up. For example, determining eligibility of mobile payment cards can prevent a user from entering card data corresponding to ineligible mobile payment cards into the mobile wallet. As such, manual entry of irrelevant card information can be avoided during set-up of the mobile wallet. Additional benefits of determining mobile payment card eligibility include streamlining mobile wallet maintenance, decreasing the likelihood of subsequent card transaction failures, and decreasing the communication traffic between the mobile computing device 102 and the user account server 106.

An eligible payment card data set 160 associated with the eligible mobile payment card list 148 is then sent to the mobile computing device 102 from the user account server 108, and is stored in the mobile wallet program 130. The eligible payment card data set 160 may include eligible mobile payment data 162 pertaining to the one or more eligible mobile payment cards 150 in the eligible mobile payment card list 148. The eligible mobile payment card data 162 may include card identifiers, expiration dates, card types, tokens, card issuers, card images (e.g., logos) etc. In this way, a user can be provided with relevant mobile payment cards to choose from for subsequent card enrollment in the mobile wallet program.

After eligible payment card data set 160 is received by the mobile computing device 102, a user of the device may then be prompted to enroll one or more cards in the eligible mobile payment card list 148. Enrollment may include taking a mobile payment card stored on the user account server 106 and the payment card server 108 and placing an instance of the mobile payment card, which may be equipped to perform a transaction, in the mobile wallet program 130. For example, the list of eligible payment cards may be presented on a graphical user interface (GUI) with a button enabling the user to select mobile payment cards to enroll.

After a user has initiated/requested enrollment or enrollment has been automatically triggered, an enrollment request may be sent from the mobile computing device 102 to the payment card server 108. In some examples, the user account server 106 may act as an intermediary, relaying the enrollment request to the payment card server 108. The payment card server 108 may be configured to enroll the user-selected mobile payment card when the enrollment request is received. Enrollment of the user-selected mobile payment card can include steps that enable the mobile payment card to be used in a transaction through operation of the mobile wallet program 130. For example, an instance of the mobile payment card may be sent to the mobile wallet program 130 when the payment card server 108 initiates card enrollment. The instance of the mobile payment card may include card data used during a transaction with the payment device 104. In one example, selected card data contained in the mobile payment card sent to the mobile wallet program 130 may be masked/omitted to increase security. For instance, only a portion (e.g., last four digits) of the mobile payment card's identification numbers may be sent to the mobile wallet program. Various security measures may be employed during the mobile payment card enrollment process, such as requiring the user of the mobile computing device 102 to provide verification data (e.g., a security code, a password, etc.,) which can be verified by the user account server 106 and/or the payment card server 108.

Additionally, mobile payment card data 146 may be stored in the payment card database 144 in the payment card server 108. The mobile payment card data 146 can include any information enabling the payment card server 108 to implement a transaction with selected mobile payment cards. The mobile payment card data 146 may be generated by the payment card server 108 when a payment card is issued. Specifically, the mobile payment card data 146 may include card issuers, usernames, payment card numbers, security codes, expiration dates, etc., and other information enabling card transactions to be verified and processed. It will be appreciated that the mobile payment card data 146 may include additional or alternative card data than card data stored in the user account 134. For example, security data such as encryption/authentication data, algorithms, etc., may only be included in the mobile payment card data 146, to increase card security and reduce the likelihood of fraudulent card use. Further in one example, the mobile payment card data 146 may be sent to the user account server 106 to generate the mobile payment card list 132.

Once the enrollment process has concluded, a user can use the enrolled mobile payment card to engage in transactions with payment devices, such as device 104. A transaction may be implemented using near field communication (NFC) or other suitable wired/wireless communication technique. Implementing the transaction may include sending a transaction token to the payment device 104 from the mobile computing device 102. Such a transaction token may be used as an identifier that maps back to masked/sensitive data through the payment card server 108. The sensitive data may include mobile payment card number, usemame, pin number, and/or security code.

When the transaction token is received at the payment device 104, the payment device may relay the transaction token to payment card server 108 to request transaction verification. The payment card server 108 can then use the transaction token to map the mobile computing device 102 and associated user to the sensitive card information needed to consummate the transaction. The token mechanism therefore enables the mobile device to carry information needed to engage in transactions, while at the same limiting the locations where the sensitive information needs to reside (typically, only on the card payment server or other secure location(s)).

The computing system 100 described above reduces user actions needed to configure mobile payment cards into the mobile wallet, eliminates manual steps that are time consuming and prone to error, and eliminates user configuration actions that ultimately turn out to be unnecessary/wasted in the event that the respective card turns out to be ineligible. The computing system 100 also streamlines mobile wallet set-up, streamlines mobile wallet maintenance, avoids failed transactions, and enhances mobile wallet security.

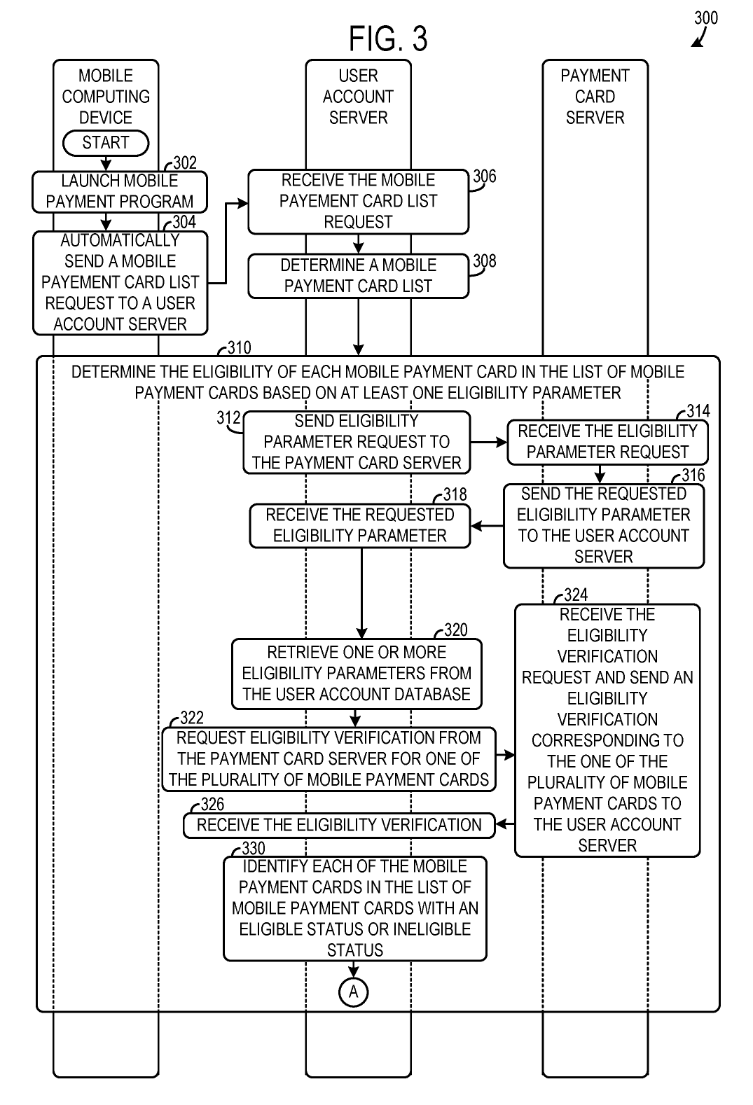

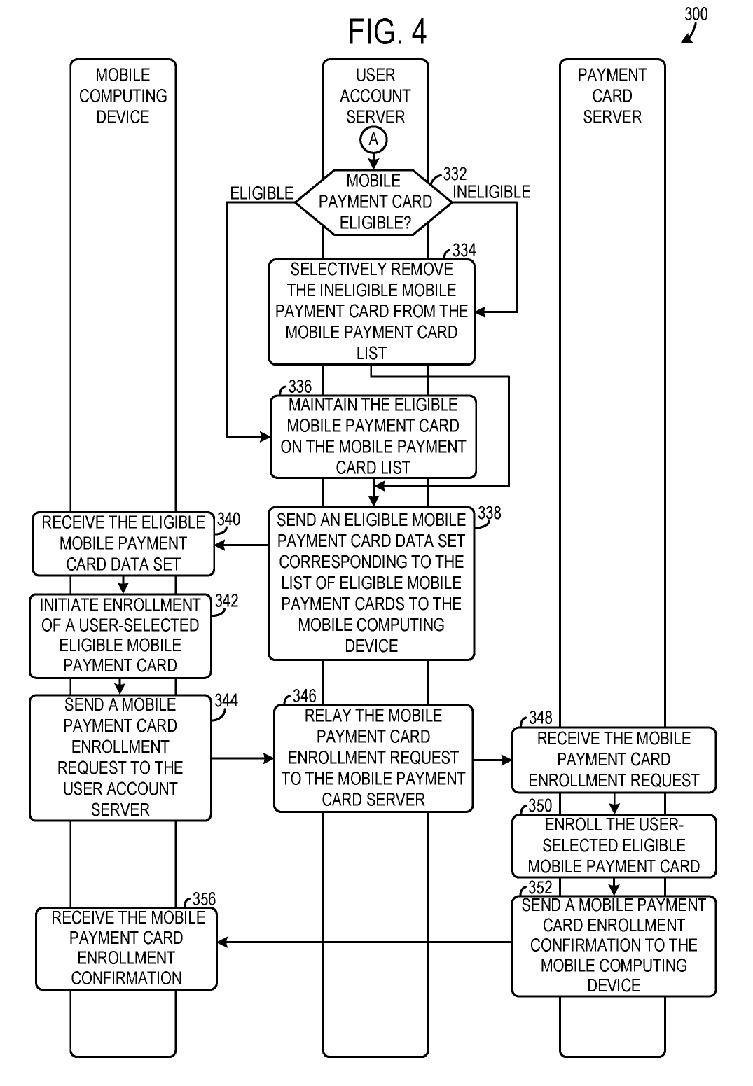

FIGS. 3-4 show a method 300 for operating a computing system to provide mobile wallet functionality, with an emphasis on enhancing certain aspects of mobile wallet set up. As shown, the method may be implemented by a mobile computing device, a user account server, and/or a payment card server. Specifically, the mobile computing device 102, user account server 106, and payment card server 108 described in FIGS. 3-4 may be used to implement the method 300. However in other examples, other suitable devices and servers may be used to implement the method 300. In some of the examples, particular actions will be attributed to specific devices (e.g., the mobile computing device 102). It should be understood however, that many/most actions can be performed in whole or in part by other devices.

Continuing with the method, it includes, at 302, launching a mobile payment program. Typically, this is performed at the mobile computing device. Next, at 304, the method includes automatically sending a mobile payment card list request to the user account server from the mobile computing device in response to launch. In this way, user actions needed to configure mobile payment cards are reduced, streamlining the mobile wallet set-up process. It will be appreciated however, that other methods may be employed, including explicit user input, to send the mobile payment card list request to the server.

As indicated at 306, the method includes receiving the mobile payment card list request at the user account server. Next, at 308, the method includes determining a mobile payment card list at the user account server in response to receiving the mobile payment card list request.

The mobile payment card list is associated with the mobile computing will device and includes information associated with a plurality of mobile payment cards stored in a user account database. At 310, the method includes determining an eligibility of each mobile payment card in the list of mobile payment cards based on at least one eligibility parameter. Determining eligibility of the mobile payment cards enables failed downstream transactions due to ineligibility to be avoided and eliminates unnecessary user configuration actions. As such, mobile wallet set up may be streamlined and frustrations associated with failed transactions can be avoided. The eligibility determination may be carried out via interaction between the user account server, the mobile computing device, and/or mobile payment card server, and in the present example includes steps 312-330.

At 312, the method includes, at the user account server, sending an eligibility parameter request to the payment card server from the user account server. Next, at 314, the method includes receiving the eligibility parameter request at the payment card server and, at 316, the method further includes sending the requested eligibility parameter to the user account server from the payment card server. The requested eligibility parameter may be an expiration or suspension parameter used to ascertain if a mobile payment card is in an expired/unexpired or suspended/unsuspended states, as discussed above with regard to FIG. 2.

Next at 318 the method includes receiving the requested eligibility parameter. At 320 the method includes retrieving one or more eligibility parameters from the user account database. It will be appreciated that the eligibility parameters sent from the mobile computing device and the payment card server may be stored in the user account database as well as other eligibility parameters such as a card type parameter designating a supported card type.

At 322 the method includes requesting eligibility verification from the payment card server for one of the plurality of mobile payment cards. At 324 the method includes, at the payment card server, receiving the eligibility verification request and sending an eligibility verification corresponding to the one of the plurality of mobile payment cards to the user account server.

At 326 the method includes receiving eligibility verification of the one of the plurality of mobile payment cards from the payment card server. At 330 the method includes identifying each of the mobile payment cards in the list of mobile payment cards with an eligible status or ineligible status based on the eligibility parameters retrieved from the user account database. As previously discussed, various states of the mobile payment card may be used to assess eligibility such as suspended/unsuspended states, expired/unexpired states, etc. As such, expired and suspended mobile payment cards may be flagged as being ineligible.

Additionally, when a user preference parameter is used to determine mobile payment card eligibility, a characteristic of the mobile payment card may be compared with a user-approved mobile payment card characteristic. If the characteristics match one another, the mobile payment card is identified with an eligible status. On the other hand, if the characteristics do not match one another, the mobile payment card is identified with an ineligible status. For instance, a parent may want to block a payment card provided to their children from being used in a mobile wallet. Thus, the parent may identify certain card users as being ineligible for mobile wallet use.

In yet another example, when a card type parameter is used to determine mobile payment card eligibility, a card type of the mobile payment card may be compared to a supported card type designated by the card type parameter. If the card type of the mobile payment card matches the supported card type the mobile payment card is identified with an eligible status. However, if the card type of the mobile payment card does not match the supported card type the mobile payment card is identified with an ineligible status. For example, only credit and/debit type mobile payment cards may be eligible and gift type mobile payment cards may be ineligible.

Turning to FIG. 4, at 332 the method may advance to selected steps based on mobile payment card eligibility/ineligibility identified in step 330. If the mobile payment card is ineligible, the example method advances to 334 where ineligible mobile payment cards are selectively removed from the mobile payment card list. However, if the mobile payment card is eligible, it is retained within the mobile payment card list, as shown at 336.

As shown at step 338, the method may also include sending, from the mobile computing device to the user account server, an eligible mobile payment card data set corresponding to the list of selected eligible mobile payment cards. Next, at 340, the method includes receiving the eligible mobile payment card data set at the mobile computing device. In one example, the eligible mobile payment card data set may include card data associated with individual eligible cards such as card issuer, a portion of the card's identification number, a card user's name, etc. The eligible mobile payment card data set may also include a token that provides the above-described mapping to sensitive information stored on the user account server and/or payment card server. Using a token in this way enables sensitive card information to he restricted from residing on the mobile computing device, which typically will be less secure than the associated cloud-located user account.

At 342, the method includes initiating enrollment of a user-selected eligible mobile payment card. Initiating enrollment of a user-selected eligible payment card may include entering verification data such as the card security code, the card identification number, etc. At 344, the method includes sending a mobile payment card enrollment request to the user account server from mobile computing device. It will be appreciated that the verification data may be sent with the enrollment request to increase enrollment security. Moreover, the enrollment request may be generated responsive to user input indicating a desire to enroll a selected mobile payment card in the list of eligible mobile payment cards.

At 346 the method includes, at the user account server, relaying the mobile payment card enrollment request to the mobile payment card server. At 348, the method includes receiving the mobile payment card enrollment request at the mobile payment card server. Next, at 350, the method includes enrolling the user-selected eligible mobile payment card at the mobile payment card server. Enrolling the user-selected eligible mobile payment card may include placing the mobile payment card in a condition where mobile payment card transactions with the mobile payment card are permitted. In one example, enrollment of the user-selected eligible mobile payment card may include generating a token associated with the mobile payment card.

As shown at 352 and 356, a mobile payment card enrollment confirmation is sent to and received at the mobile computing device. In some examples, confirmation includes a token that can be used to carry out transactions without any need to store/exchange sensitive information.

Method 300 enables mobile wallet set-up to be simplified/streamlined by reducing user actions necessary to configure cards into the mobile wallet, by eliminating manual steps that are time consuming and prone to error, and by eliminating user configuration actions that ultimately turn out to be unnecessary/wasted in the event that the respective card turns out to be ineligible. Moreover, method 300 enable mobile wallet maintenance to be streamlined, avoids failed transactions, and enhances mobile wallet security.

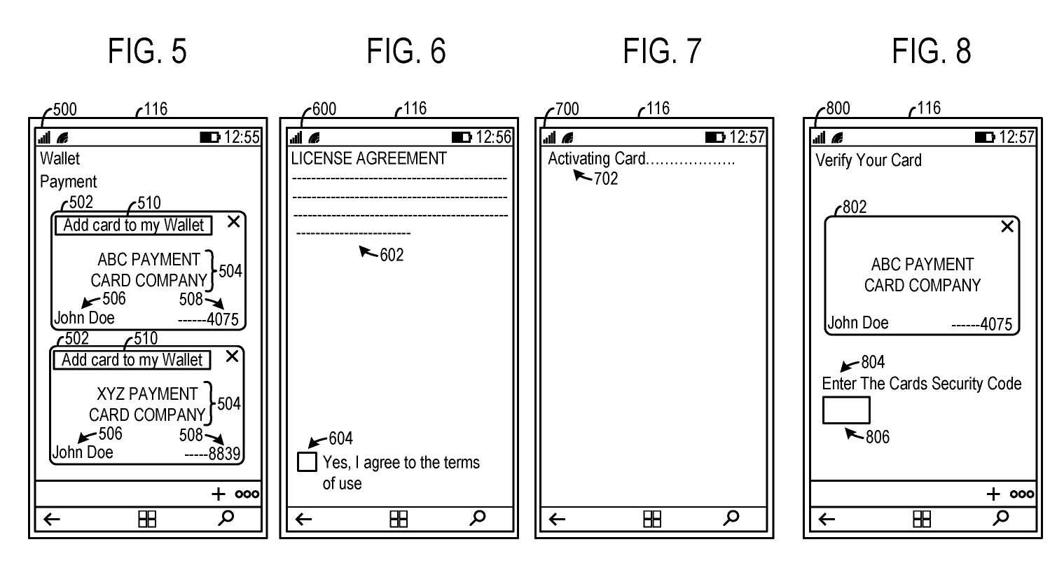

FIGS. 5-8 show different graphical user interfaces (GUIs) that may be presented on the display 116 of the mobile computing device 102 shown in FIG. 1. The GUIs show eligible mobile payment cards to the user and enable user-selected cards to be subsequently verified and enrolled.

Specifically FIG. 5 shows a GUI 500 presented on the display 116 including one or more eligible mobile payment card representations 502. Each of the eligible mobile payment card representations 502 includes the payment card issuer identifier 504, card user name 506, and a portion of the mobile payment card's number 508. Specifically, in the depicted example, only the last four digits of the payment card's number are displayed to enable a user o recognize the card without compromising card security. Masking card information in this way also enables a decreased (e.g., minimal) amount identification information to be sent to the payment device (e.g., POS device) during a transaction. For example, only a token may be sent to the payment device from the mobile computing device during a transaction. The payment device can then upload the token to get transaction authorization from the card issuer where the masked card information may be securely accessed.

In one example, the eligible mobile payment card representations 502 may be generated based on a standardized card template and not on original card art. The standardized card template can enable various aesthetics of the card to be locally generated at the mobile computing device without additional interaction with the user account server and/or payment card server which may increase the efficiency of the mobile wallet set-up process. However, in other examples, the eligible mobile payment card representations 502 may have a similar appearance to their physical card counterpart. The eligible mobile payment card representations 502 may also include a user account server logo, in some examples. Buttons 510 prompting a user to enroll the each of the mobile payment cards are also provided in the GUI 500. A user may actuate one of the buttons 510 via input (e.g., touch input.)

In response to button or other actuation, a license agreement 602 with a check box 604 may be displayed in GUI 600 shown in FIG. 6, the license agreement corresponding to the mobile payment card selected for activation. The check box 604 prompts the user to agree to the license agreement 602.

If the user agrees to the license agreement 602 (e.g., by selecting the check box 604), a GUI 700, shown in FIG. 7, may be presented on the display 116. GUI 700 conveys to the user that the card is being activated via notification 702. Activation of the card may be a step in the enrollment process, such as the enrollment process discussed above with regard to FIGS. 1-4.

After the mobile payment card is activated, a GUI 800 may be presented on the display 116, as shown in FIG. 8. The GUI 800 displays a mobile payment card 802 that has been added to the mobile wallet. Notification 804 prompting a user to enter the card's security code into box 806 may be provided in the GUI 800. The user may then inspect the physical payment card for the security code and then enter the security code into the text box 806. In this way, additional security procedures can be employed during card set-up.

In some embodiments, the methods and processes described herein may be tied to a computing system of one or more computing devices. In particular, such methods and processes may be implemented as a computer-application program or service, an application-programming interface (API), a library, and/or other computer-program product.

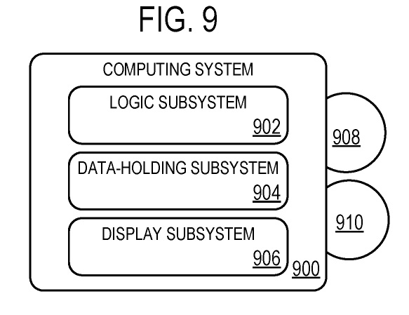

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic subsystem 902 and a data-holding subsystem 904. Computing system 900 may optionally include a display subsystem 906, input subsystem 908, communication subsystem 910, and/or other components not shown in FIG. 9.

Logic subsystem 902 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic subsystems configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Data-holding subsystem 904 includes one or more physical devices configured to hold instructions executable by the logic subsystem to implement the methods and processes described herein. When such methods and processes are implemented, the state of data-holding subsystem 904 may be transformed—e.g., to hold different data.

Data-holding subsystem 904 may include removable and/or built-in devices. Data-holding subsystem 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Data-holding subsystem 904 may include volatile, nonvolatile, dynamic, static, read/write, read-only, random-access, sequential-access, location-addressable, file-addressable, and/or content-addressable devices.

It will be appreciated that data-holding subsystem 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 902 and data-holding subsystem 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic subsystem 902 executing instructions held by data-holding subsystem 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by data-holding subsystem 904. This visual representation may take the form of a graphical user interface (GUI). As the herein described methods and processes change the data held by the data-holding subsystem, and thus transform the state of the data-holding subsystem, the state of display subsystem 906 may likewise be transformed to visually represent changes in the underlying data. Display subsystem 906 may include one or more display devices utilizing virtually any type of technology. Such display devices may be combined with logic subsystem 902 and/or data-holding subsystem 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

The subject matter of the present disclosure is further described in the following paragraphs. According to one aspect, a user account server is provided. The user account server includes code stored in memory executable by a processor to receive a mobile payment card list request from a mobile computing device, determine a mobile payment card list associated with the mobile computing device in response to receiving the mobile payment card list request, the mobile payment card list including a plurality of mobile payment cards stored in a user account database, determine an eligibility of each mobile payment card in the mobile payment card list based on at least one eligibility parameter, if a mobile payment card is determined to be ineligible, selectively remove the ineligible mobile payment card from the mobile payment card list to generate a list of eligible mobile payment cards, and send an eligible mobile payment card data set corresponding to the list of eligible payment cards to the mobile computing device.

In this aspect, the at least one eligibility parameter may be an eligibility verification parameter, and where determining eligibility of each mobile payment card includes requesting eligibility verification from the payment card server for one of the plurality of mobile payment cards and receiving eligibility verification of the one of the plurality of mobile payment cards from the payment card server.

In this aspect, the mobile computing device may automatically send the mobile payment card list request to the user account server in response to launching a mobile wallet program.

In this aspect, the at least one eligibility parameter may be an expiration parameter set by the payment card server, and where determining eligibility of each mobile payment card in the mobile payment card list includes determining if a mobile payment card is in an expired state or unexpired state based on the expiration parameter and if the mobile payment card is in the expired state, identifying the mobile payment card with an ineligible status.

In this aspect, the at least one eligibility parameter may be a suspension parameter set by the payment card server and determining eligibility of each mobile payment card in the mobile payment card list includes determining if a mobile payment card is in a suspended state or unsuspended state based on the suspension parameter and if the mobile payment card is in the suspended state, identifying the mobile payment card with an ineligible status.

In this aspect, where the at least one eligibility parameter may be a user preference parameter designating a user-approved mobile payment card characteristic, and where determining eligibility of each mobile payment card in the mobile payment card list includes determining if a characteristic of a mobile payment card matches the user-approved mobile payment card characteristic and if the characteristic of the mobile payment card does not match the user-approved mobile payment card characteristic, identifying the mobile payment card with an ineligible status. In this aspect, the at least one eligibility parameter may include a card type parameter designating a supported card type and determining eligibility of each mobile payment card in the mobile payment card list includes determining if a card type of a mobile payment card matches the supported card type and if the card type of the mobile payment card does not match the supported card type, identifying the mobile payment card with an ineligible status.

In this aspect, the user account server may further include code stored in memory executable by the processor to enroll a mobile payment card in the list of eligible mobile payment cards in response to receiving an enrollment request from the mobile computing device.

In this aspect, enrolling the mobile payment card may include sending a token associated with the mobile payment card to the mobile computing device from the user account server, the token enabling identification of the mobile payment card during a payment card transaction.

In this aspect, the plurality of mobile payment cards may include one or more of a mobile debit card, a mobile credit card, and a mobile gift card.

In this aspect, the at least one eligibility parameter may be set by one or more of the user account server, the mobile computing device, and a payment card server.

According to another aspect, a method for operating a user account server is provided. The method includes at the user account server, receiving a mobile payment card list request from a mobile computing device, determining a mobile payment card list associated with the mobile computing device in response to receiving the mobile payment card list request, the mobile payment card list including a plurality of mobile payment cards stored in a user account database, determining an eligibility of each mobile payment card in the mobile payment card list based on at least one eligibility parameter, if a mobile payment card is determined to be ineligible, selectively removing the ineligible mobile payment card from the mobile payment card list to generate a list of eligible mobile payment cards, and sending an eligible mobile payment card data set corresponding to the list of eligible payment cards to the mobile computing device.

In this aspect, the at least one eligibility parameter may be an eligibility verification parameter and determining eligibility of each mobile payment card includes requesting eligibility verification from the payment card server for one of the plurality of mobile payment cards, and receiving eligibility verification of the one of the plurality of mobile payment cards from the payment card server.

In this aspect, the at least one eligibility parameter may be set by one or more of the user account server, the mobile computing device, and a payment card server.

In this aspect, the at least one eligibility parameter may be an expiration parameter set by the payment card server, and where determining eligibility of each mobile payment card in the mobile payment card list includes determining if a mobile payment card is in an expired state or unexpired state based on the expiration parameter, and if the mobile payment card is in the expired state, identifying the mobile payment card with an ineligible status.

In this aspect, the at least one eligibility parameter is a suspension parameter set by the payment card server and determining eligibility of each mobile payment card in the mobile payment card list includes determining if a mobile payment card is in a suspended state or unsuspended state based on the suspension parameter, and if the mobile payment card is in the suspended state, identifying the mobile payment card with an ineligible status.

In this aspect, the at least one eligibility parameter may be a user preference parameter designating a user-approved mobile payment card characteristic, and where determining eligibility of each mobile payment card in the mobile payment card list includes determining if a characteristic of a mobile payment card matches the user-approved mobile payment card characteristic, and if the characteristic of the mobile payment card does not match the user-approved mobile payment card characteristic, identifying the mobile payment card with an ineligible status.

According to another aspect, a user account server is provided. The user account server includes code stored in memory executable by a processor to receive a mobile payment card list request from a mobile computing device with a mobile device identifier, determine a mobile payment card list associated with the mobile computing device in response to receiving the mobile payment card list request and based on the mobile device identifier, the mobile payment card list including a plurality of mobile payment cards stored in a user account database, retrieve a plurality of eligibility parameters stored in the user account database in the user account server, determine an eligibility of each mobile payment card in the mobile payment card list based on the plurality of eligibility parameters, if a mobile payment card is determined to be ineligible, selectively remove the ineligible mobile payment card from the mobile payment card list to generate a list of eligible mobile payment cards, send an eligible mobile payment card data set corresponding to the list of eligible payment cards to the mobile computing device, and enroll a mobile payment card in the list of eligible mobile payment cards in response to receiving an enrollment request from the mobile computing device.

In this aspect, the plurality of eligibility parameters may include an expiration parameter set by the payment card server, and where determining eligibility of each mobile payment card in the mobile payment card list includes determining if a mobile payment card is in an expired state or unexpired state based on the expiration parameter, and if the mobile payment card is in the expired state, identifying the mobile payment card with an ineligible status.

In this aspect, the plurality of eligibility parameters may include a suspension parameter set by the payment card server and determining eligibility of each mobile payment card in the mobile payment card list includes determining if a mobile payment card is in a suspended state or unsuspended state based on the suspension parameter, and if the mobile payment card is in the suspended state, identifying the mobile payment card with an ineligible status.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A user account server, comprising:
code stored in memory executable by a processor to:
receive a mobile payment card list request from a mobile computing device;
determine a mobile payment card list associated with the mobile computing device in response to receiving the mobile payment card list request, the mobile payment card list including a plurality of mobile payment cards stored in a user account database;
determine an eligibility of each mobile payment card in the mobile payment card list based on at least one eligibility parameter;
if a mobile payment card is determined to be ineligible, selectively remove the ineligible mobile payment card from the mobile payment card list to generate a list of eligible mobile payment cards; and
send an eligible mobile payment card data set corresponding to the list of eligible payment cards to the mobile computing device.

2. The user account server of claim 1, where the at least one eligibility parameter is an eligibility verification parameter, and where determining eligibility of each mobile payment card includes:
requesting eligibility verification from the payment card server for one of the plurality of mobile payment cards; and
receiving eligibility verification of the one of the plurality of mobile payment cards from the payment card server.

3. The user account server of claim 1, where the mobile computing device automatically sends the mobile payment card list request to the user account server in response to launching a mobile wallet program.

4. The user account server of claim 1, where the at least one eligibility parameter is an expiration parameter set by the payment card server, and where determining eligibility of each mobile payment card in the mobile payment card list includes:
determining if a mobile payment card is in an expired state or unexpired state based on the expiration parameter; and
if the mobile payment card is in the expired state, identifying the mobile payment card with an ineligible status.

5. The user account server of claim 1, where the at least one eligibility parameter is a suspension parameter set by the payment card server and determining eligibility of each mobile payment card in the mobile payment card list includes:
determining if a mobile payment card is in a suspended state or unsuspended state based on the suspension parameter; and
if the mobile payment card is in the suspended state, identifying the mobile payment card with an ineligible status.

6. The user account server of claim 1, where the at least one eligibility parameter is a user preference parameter designating a user-approved mobile payment card characteristic, and where determining eligibility of each mobile payment card in the mobile payment card list includes:
determining if a characteristic of a mobile payment card matches the user-approved mobile payment card characteristic; and
if the characteristic of the mobile payment card does not match the user-approved mobile payment card characteristic, identifying the mobile payment card with an ineligible status.

7. The user account server of claim 1, where the at least one eligibility parameter include a card type parameter designating a supported card type and determining eligibility of each mobile payment card in the mobile payment card list includes:
determining if a card type of a mobile payment card matches the supported card type; and
if the card type of the mobile payment card does not match the supported card type, identifying the mobile payment card with an ineligible status.

8. The user account server of claim 1, further comprising code stored in memory executable by the processor to:
enroll a mobile payment card in the list of eligible mobile payment cards in response to receiving an enrollment request from the mobile computing device.

9. The user account server of claim 8, where enrolling the mobile payment card include sending a token associated with the mobile payment card to the mobile computing device from the user account server, the token enabling identification of the mobile payment card during a payment card transaction.

10. The user account server of claim 1, where the plurality of mobile payment cards include one or more of a mobile debit card, a mobile credit card, and a mobile gift card.

11. The user account server of claim 1, where the at least one eligibility parameter is set by one or more of the user account server, the mobile computing device, and a payment card server.

12. A method for operating a user account server, comprising:
at the user account server, receiving a mobile payment card list request from a mobile computing device;
determining a mobile payment card list associated with the mobile computing device in response to receiving the mobile payment card list request, the mobile payment card list including a plurality of mobile payment cards stored in a user account database;
determining an eligibility of each mobile payment card in the mobile payment card list based on at least one eligibility parameter;
if a mobile payment card is determined to be ineligible, selectively removing the ineligible mobile payment card from the mobile payment card list to generate a list of eligible mobile payment cards; and
sending an eligible mobile payment card data set corresponding to the list of eligible payment cards to the mobile computing device.

13. The method of claim 12, where the at least one eligibility parameter is an eligibility verification parameter and determining eligibility of each mobile payment card includes:
requesting eligibility verification from the payment card server for one of the plurality of mobile payment cards; and
receiving eligibility verification of the one of the plurality of mobile payment cards from the payment card server.

14. The method of claim 12, where the at least one eligibility parameter is set by one or more of the user account server, the mobile computing device, and a payment card server.

15. The method of claim 2, where the at least one eligibility parameter is an expiration parameter set by the payment card server, and where determining eligibility of each mobile payment card in the mobile payment card list includes:
determining if a mobile payment card is in an expired state or unexpired state based on the expiration parameter; and
if the mobile payment card is in the expired state, identifying the mobile payment card with an ineligible status.

16. The method of claim 12, where the at least one eligibility parameter is a suspension parameter set by the payment card server and determining eligibility of each mobile payment card in the mobile payment card list includes:
determining if a mobile payment card is in a suspended state or unsuspended state based on the suspension parameter; and
if the mobile payment card is in the suspended state, identifying the mobile payment card with an ineligible status.

17. The method of claim 12, where the at least one eligibility parameter is a user preference parameter designating a user-approved mobile payment card characteristic, and where determining eligibility of each mobile payment card in the mobile payment card list includes:
determining if a characteristic of a mobile payment card matches the user-approved mobile payment card characteristic; and
if the characteristic of the mobile payment card does not match the user-approved mobile payment card characteristic, identifying the mobile payment card with an ineligible status.

18. A user account server, comprising:
code stored in memory executable by a processor to:
receive a mobile payment card list request from a mobile computing device with a mobile device identifier,
determine a mobile payment card list associated with the mobile computing device in response to receiving the mobile payment card list request and based on the mobile device identifier, the mobile payment card list including a plurality of mobile payment cards stored in a user account database;
retrieve a plurality of eligibility parameters stored in the user account database in the user account server:
determine an eligibility of each mobile payment card in the mobile payment card list based on the plurality of eligibility parameters;
if a mobile payment card is determined to be ineligible, selectively remove the ineligible mobile payment card from the mobile payment card list to generate a list of eligible mobile payment cards;
send an eligible mobile payment card data set corresponding to the list of eligible payment cards to the mobile computing device; and
enroll a mobile payment card in the list of eligible mobile payment cards in response to receiving an enrollment request from the mobile computing device.

19. The user account server of claim 18, where the plurality of eligibility parameters include an expiration parameter set by the payment card server, and where determining eligibility of each mobile payment card in the mobile payment card list includes:
determining if a mobile payment card is in an expired state or unexpired state based on the expiration parameter; and
if the mobile payment card is in the expired state, identifying the mobile payment card with an ineligible status.

20. The user account server of claim 18, where the plurality of eligibility parameters include a suspension parameter set by the payment card server and determining eligibility of each mobile payment card in the mobile payment card list includes:
determining if a mobile payment card is in a suspended state or unsuspended state based on the suspension parameter; and
if the mobile payment card is in the suspended state, identifying the mobile payment card with an ineligible status.
